(19) United States
(12) Patent Application Publication
(10) Pub. No.: US 2004/0175188 A1
(43) Pub. Date: Sep. 9, 2004

(54) Optical sources and transmitters for optical telecommunications

(76) Inventors: Antoine Bellemare, Quebec (CA); Habib Fathallah, Sainte-Foy (CA); Louis-Patrick Boulianne, St-Nicolas (CA); Lionel Pujol, Quebec (CA)

Correspondence Address: Baker & Hostetler, Washington Square, Suite 1100, 1050 Connecticut Avenue NW, Washington, DC, 20036, US

(21) Appl. No.: 10/475,111

(22) PCT Filed: Apr. 18, 2002
(86) PCT No.: PCT/CA02/00524

Related U.S. Application Data
(60) Provisional application No. 60/284,194, filed on Apr. 18, 2001.

(51) Int. Cl. H04B 10/04

(52) U.S. Cl. 398/186

(57) ABSTRACT

Optical sources and transmitters for transmitting data in a spectro-temporally encoded light signal are provided. The optical source includes a pumped gain medium for generating ASE radiation. A wavelength dependent reflector is provided backward of the gain medium for reflecting wavebands adapted for spectro-temporal encoding. In one embodiment, a modulator and an encoder are provided outside of the source for embedding data into the generated signal spectro-temporally encoding this signal. In another embodiment, the wavelength dependent reflector acts as the encoder, and the modulator is provided inside the source.

### FIELD OF THE INVENTION

The present invention relates to the field of active components for fiber optics communication networks and more particularly concerns incoherent optical fiber sources, transmitters and transmitter arrays with waveband output power spectra.

### BACKGROUND OF THE INVENTION

With the ever increasing consumers' demand for high-bandwidth bi-directional multipoint to multipoint communication applications, fiber optics networks are asked to distribute information between an increasing number of terminals at constantly higher bit rates. This requires that information be quickly routed from the sender to the proper recipient, either by an optical switch or by wavelength routing. In a proposed network architecture described in a co-pending patent application (H. Fathallah, “Fast frequency hopping spread spectrum for code division multiple access communications networks,” U.S. Ser. No. 09/192,180 and Canada no. 2,249,877) time and wavelength (spectro-temporal codes) are used to encode information in such a way that only the recipient with the proper decoder can retrieve the information, which was broadcast to all the receiving terminals in the network. One way to generate these spectro-temporal codes is to “slice and delay” the light from a broadband optical source. In the “slice and delay” technique, an optical pulse from the broadband source is sliced in many wavelength bands (or wavebands), each one being delayed relative to the other in such a way that an optical code is generated. In that context, it is clear to anyone well versed in the art that the design of high power spectral density and high optical signal-to-noise ratio broadband source is a very important part of the whole network design.

Other data transmitting and encoding schemes include for example “spectrum slicing” schemes, also called Frequency Encoding (FE), see for example T. Pfeiffer et al., Electronics Letters, vol.33, no.25, pp.2141-2142, 1997, or Incoherent Wavelength Division Multiplexing (I-WDM), see for example M. Zirngibl et al., IEEE Photonics Technology Letters, vol.8, no.5, pp.721-723, 1996, for multi-wavelength or single-wavelength output spectra respectively. In all of these cases, high power spectral density and high optical signal-to-noise ratio broadband source are of important practical concern.

There is therefore a need for waveband incoherent optical fiber sources and transmitters for fiber optics communication networks with enhanced power spectral density.

FIG. 1 (PRIOR ART) shows a diagram of a prior art realisation of the transmitter used in fiber optic CDMA (Code Division Multiple Access) networks. A directly modulated superluminescent light emitting diode (SLED) output power is “sliced and delayed” by the encoder to generate the “spectro-temporal” coded data bits. In the illustrated embodiment, the codes are obtained by fiber Bragg gratings (FBG) encoders, but other techniques are also possible.

Since high power SLED are somewhat costly and not widely available commercially, a sound alternative would be to use erbium-doped fiber superfluorescent sources (EDF-SFS). EDF-SFS are easily built, power scalable, and readily fiber compatible. In preferred configurations of such sources, one or a multitude of narrowband reflectors (each having a different operating wavelength) are placed at one end of an erbium-doped fiber (EDF) which is pumped through a wavelength dependent coupler (WDC) by a pump laser diode emitting preferably around 980 or 1480 nm. The preferred narrowband reflectors for these sources are fiber Bragg gratings (FBG) since they are readily fiber compatible. These sources yield output power spectra having a single or a multitude of discrete narrowband spectral components depending on the number of reflectors used.

Referring to FIGS. 2A and 2B (PRIOR ART), there are shown examples of prior art embodiments of double-pass superfluorescent erbium-doped fiber source configurations. FIG. 2A, shows such a source where a multitude of fiber Bragg gratings are concatenated to form a multiwavelength reflector as taught in U.S. Pat. No. 5,191,586 (Huber). In FIG. 2B, taken from U.S. Pat. No. 6,195,200 (DeMarco et al.), a single multiwavelength reflector is proposed. The double-pass design increases the power spectral density of the source and the optical signal-to-noise ratio (OSNR).

In a similar fashion, a continuous spectrum broadband source can be realised by using a single broadband reflector, like chirped Bragg gratings (CBG), instead of narrowband reflectors. A journal article (Dyer and Rochford, “Spectral tailoring of erbium superfluorescent fibre source,” Electronics Letters, vol.34, no.11, pp.1137-1139, 1998) describes such a source.

Known prior art devices are not, however, optimised for optical CDMA communications. There is therefore a need for incoherent fiber optic sources and transmitters with power spectral densities optimised for specific wavebands that allow the generation of spectro-temporally encoded data signals. More generally, there is also a need for optical sources and transmitter better adapted to optical telecommunication schemes than known prior art devices.

### OBJECTS AND SUMMARY OF THE INVENTION

It is therefore an object of the present invention to provide optical sources and transmitters particularly adapted to optical telecommunications.

It is therefore a preferable object of the present invention to provide optical transmitters particularly adapted for the generation of spectro-temporally encoded data signals.

Accordingly, the present invention first provides an optical transmitter for transmitting data in a spectro-temporally encoded light signal. The transmitter includes an optical fiber having a backward and a forward propagation direction. A gain medium is provided in the fiber. A pump source is coupled to the optical fiber for injecting pump radiation in the gain medium. In this manner the generation by the gain medium of a broadband light signal is enabled. At least a portion of the broadband light signal propagates in the backward direction.

The optical transmitter also includes a wavelength dependent reflector which is coupled to the optical fiber, for reflecting a portion of the backward propagating broadband light signal into a spectrally designed signal propagating in the forward direction. The spectrally designed signal has a plurality of peak wavebands.

An amplitude modulator is further coupled to the optical fiber, forward of the gain medium, for modulating the amplitude of the spectrally designed signal in accordance with said data. An encoder is then provided and coupled to the amplitude modulator for receiving the modulated spectrally designed signal therefrom. The encoder separates the modulated spectrally designed signal into the wavebands, and time spreads these wavebands according to a predetermined code to obtain the spectro-temporally encoded light signal.

In accordance with another aspect of the invention, there is provided another optical transmitter for transmitting data in a spectrally designed light signal. This transmitter also includes an optical fiber having a backward and a forward propagation direction, a gain medium being provided therein, and a pump source coupled to the optical fiber for injecting pump radiation in the gain medium. This enables the generation by the gain medium of a broadband light signal, at least a portion of this broadband light signal propagating in the backward direction.

The transmitter also includes an amplitude modulator coupled to the optical fiber backward of the gain medium, The transmitter modulates the amplitude of the broadband light signal in accordance with the data. A wavelength dependent reflector is coupled to the amplitude modulator to receive therefrom the modulated broadband light signal. The wavelength dependent reflector reflects the modulated broadband light signal into peak wavebands, defining the spectrally designed light signal.

In accordance with yet another aspect of the present invention there is provided a pulsed waveband incoherent light source for generating a pulsed spectrally designed signal. This light source includes an optical fiber having a backward and a forward propagation direction, a gain medium being provided therein. A pump source is coupled to the optical fiber for injecting pump radiation in the gain medium, thereby enabling the generation by the gain medium of a broadband light signal. At least a portion of the broadband light signal propagates in the backward direction. A wavelength dependent reflector is also coupled to the optical fiber for reflecting a portion of the backward propagating broadband light signal into a spectrally designed signal, propagating in the forward direction. The spectrally designed signal has a plurality of peak wavebands Finally, a pulsing amplitude modulator is coupled to the optical fiber backwards of the gain medium for pulsing the spectrally designed signal.

In accordance with still another aspect of the present invention, there is provided an optical transmitter array for transmitting a plurality of data in a multiplexed plurality of spectrally designed light signals, said transmitter comprising:

a plurality of optical transmitter, each comprising:

a length of optical fiber having a backward and a forward propagation direction, a gain medium being provided therein, said gain medium generating a broadband light signal upon pumping thereof, at least a portion of said broadband light signal propagating in the backward direction;

an amplitude modulator coupled to the optical fiber backward of the gain medium for modulating an amplitude of the broadband light signal in accordance with corresponding data; and

an wavelength dependent reflector coupled to the amplitude modulator to receive therefrom the modulated broadband light signal, the wavelength dependent reflector reflecting said modulated broadband light signal into peak wavebands defining one of said spectrally designed light signals;

the transmitter array further comprising:

a pump source for injecting pump radiation into the gain medium of each optical transmitter;

an output for outputting the multiplexed plurality of spectrally designed light signals; and

a bi-directional coupling sub-assembly for respectively:

along the backward direction, splitting the pump radiation into a plurality of pump radiation portions, and injecting each of said pump radiation portions into the length of optical fiber of one of the optical transmitter to pump the corresponding gain medium; and

along the forward direction, multiplexing the spectrally designed light signals from each of the optical transmitters to obtain the multiplexed plurality of spectrally designed light signals, and directing the same towards the output.

Finally, in accordance with yet another aspect of the present invention, there is provided an optical transmitter array for transmitting a plurality of data in a multiplexed plurality of waveband light signals, said transmitter array comprising:

an optical fiber having a backward and a forward propagation direction, a gain medium being provided therein;

a pump source coupled to the optical fiber for injecting pump radiation in the gain medium, thereby enabling the generation by the gain medium of a broadband light signal, at least a portion of said broadband light signal propagating in the backward direction;

a plurality of amplitude modulators coupled to the optical fiber backward of the gain medium for receiving therefrom a waveband light signal and modulating an amplitude thereof in accordance with corresponding data; and

a wavelength division multiplexer connected to the optical fiber backward of the optical fiber for receiving therefrom the broadband light signal, said wavelength division multiplexer having a plurality of ports each coupled to one of the amplitude modulators, the wavelength division multiplexer transmitting one waveband light signal of the broadband light signal to each of said port and receiving therefrom said waveband light signal after modulation, the wavelength division multiplexer further multiplexing the waveband light signals into the multiplexed waveband light signal and coupling the same back into the optical fiber. Other features and advantages of the present invention will be better understood upon reading of preferred embodiments thereof with reference to the appended drawings.

### BRIEF DESCRIPTION OF THE DRAWINGS

FIG. 1 (PRIOR ART) is a diagram of an optical fiber transmitter using a SLED optical source.

FIGS. 2A and 2B (PRIOR ART) are diagrams of incoherent optical fiber sources.

FIG. 3 is a diagram of an optical transmitter using a waveband incoherent optical fiber source according to a preferred embodiment of the invention.

FIG. 4 is a graph showing a typical output power spectrum for the waveband incoherent optical fiber source of FIG. 3.

FIG. 5 is a diagram of a waveband incoherent optical fiber source according to another embodiment of the invention.

FIG. 6 is a graph showing the typical output power spectrum for the incoherent optical fiber source shown in FIG. 5 according to two variants thereof.

FIG. 7 is a graph showing the typical output power spectrum for a multiwavelength incoherent optical fiber source covering the 1530-1610 nm wavelength range, according to an embodiment of the invention.

FIG. 8 is a diagram showing a typical system implementation of an optical transmitter according to the invention; FIG. 8A shows a coarse WDM for use as a splitter in the embodiment of FIG. 8.

FIG. 9A is diagram showing a modulated multiwavelength incoherent optical fiber transmitter according to another embodiment of the invention. FIG. 9B is a graph showing typical results of the modulated output power (and extinction ratio) vs the pump power for the set-up of FIG. 9A.

FIG. 10 is a diagram showing a spectrum sliced short pulse generator according to an embodiment of the invention.

FIGS. 11A, 11B and 11C are diagrams showing alternative directional sub-assemblies for use in particular embodiments of the invention.

FIG. 12 is a diagram showing an array of transmitters according to another embodiment of the invention.

FIG. 13 is a diagram showing an array of transmitters according to yet another embodiment of the invention.

FIG. 14 is a diagram showing a spectrum sliced short pulse generator of another embodiment of the invention.

FIGS. 15A and 15B are diagrams showing transmitters according to an embodiment of the invention.

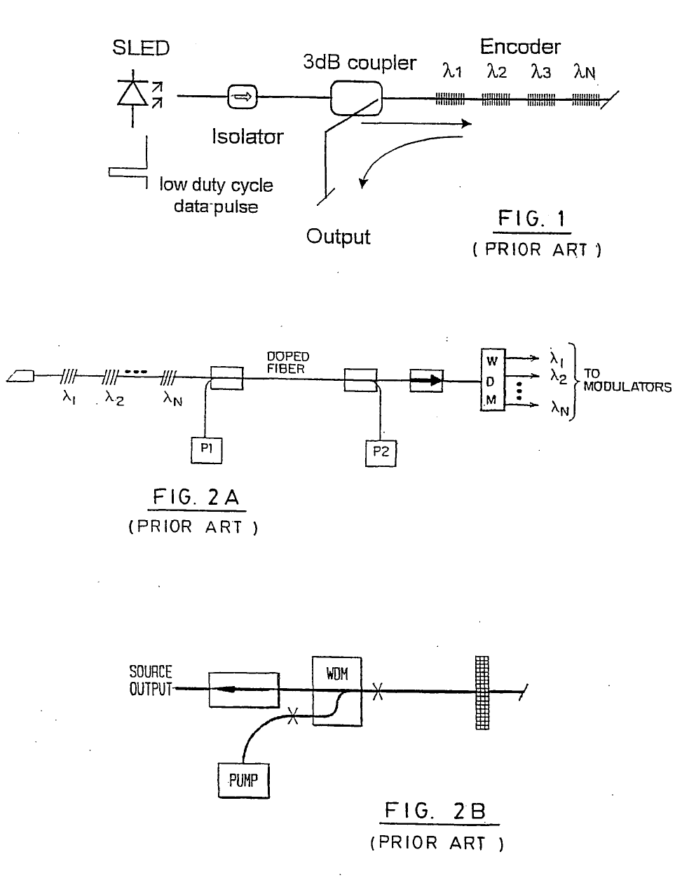

### DESCRIPTION OF PREFERRED EMBODIMENTS OF THE INVENTION

The present invention relates to the transmission of information in a fiber optic CDMA (code-division multiple access) network, by embedding data in “spectro-temporal” codes that can only be recovered by the receiver having the proper decoder. The invention therefore provides transmitters that can be realised in many different ways and in the following we will describe various preferred embodiments of the invention.

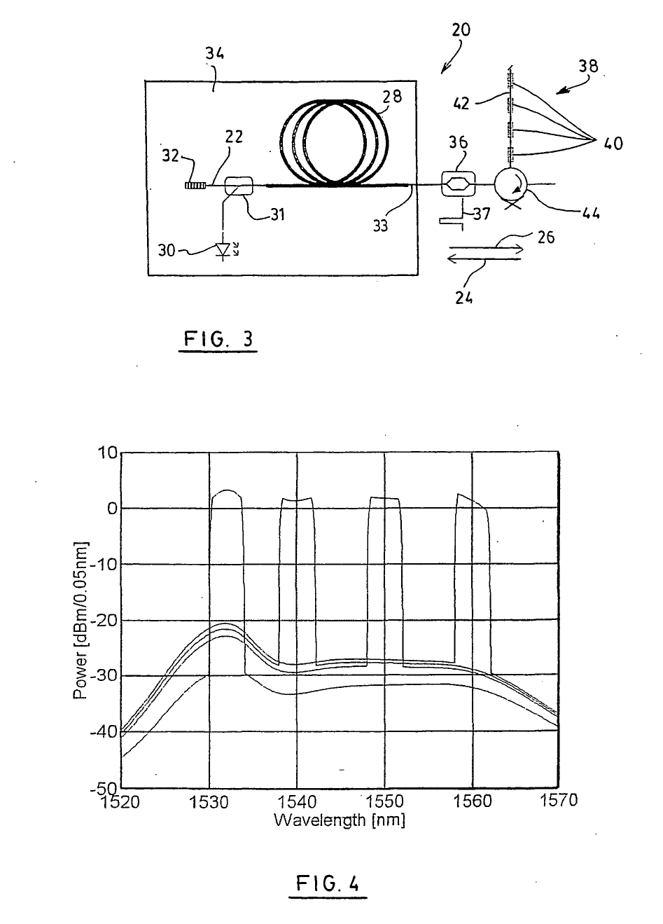

With reference to FIG. 3, there is shown an optical transmitter 20, for transmitting data in a spectro-temporally encoded light signal according to an exemplary embodiment of the present invention. The transmitter 20 is preferably based on an optical fiber 22 for easier compatibility with fiber transmission networks. It is useful to define opposite backward and a forward propagation direction 24 and 26 within the fiber, along which light propagates in a normal fashion. A gain medium 28, preferably an EDF (erbium-doped fiber), is provided. It is understood that although an EDF is a particularly advantageous choice of gain medium, other rare-earth elements could be used as alternative dopants, and that the scope of the invention is not limited to rare-earth doped fiber in any event.

In the preferred embodiment, a pump source 30 is connected to a wavelength dependent coupler (WDC) 31 for injecting pump radiation in the gain medium 28. Preferably, the pump source 30 is a pump laser diode emitting around 980 or 1480 nm, but other pump sources could also be considered. As it is well known in the art, an EDF can be forward pumped, backward pumped or bi-directionally pumped. All of these possibilities are considered within the scope of the present invention. However, it has been shown experimentally that forward pumping yields better results in terms of output power and optical signal-to-noise ratio. As it is well known in the art, pumping the gain medium 28 enables the generation of a broadband light signal by Amplified Spontaneous Emission (ASE), which generally propagates in both the backward and the forward directions 24 and 26.

The transmitter 20 also includes a wavelength dependent reflector 32. In the embodiment of FIG. 3, the reflector 32 is provided backwards of the gain medium 28. The wavelength dependent reflector 32 is used for reflecting a portion of the backward propagating broadband light signal into a spectrally designed signal propagating in the forward direction 26. The spectrally designed signal has a plurality of peak wavebands which are adapted for CDMA encoding. In other words, the wavebands reflected by the reflector are the same wavebands which will be “sliced and delayed” to obtain the spectro-temporally encoded signal. Advantageous wavelength-dependent reflectors for the purposes of the present invention are fiber Bragg gratings (FBG), since they are readily fiber compatible and can be photoinduced directly into the fiber 22, but they can be any type of wavelength-dependent reflectors such as thin films reflectors or diffraction grating reflectors.

The optical fiber 22, gain medium 28, pump source 30 and reflector 32 described above form a waveband incoherent fiber source 34 which generates a waveband spectrum adapted for encoding by the slice and delay technique. The spectrally designed signal reflected by the wavelength dependent reflector 32 propagates in the forward direction 26 into the fiber 22 and is outputted at the forward end 33 of the incoherent fiber source 34. It will therefore cross the gain medium 28 during its second passage in the fiber 22 and advantageously be amplified in its current form. FIG. 4 shows a typical output spectrum for the fiber source 34 of FIG. 3. Excellent pump power conversion (around 50%) and high optical signal-to-noise ratio (over 25 dB) can be obtained with these sources pumped at 1480 nm. 980 nm pumping is also possible and nearly as efficient. The source 34 described above therefore provides not just a thin spectrum slice, but a waveband which is sufficiently broad and uniform that it can be subsequently encoded according to the “slice and delay” technique.

Still referring to FIG. 3, following the “source” portion 34, the transmitter 20 includes an amplitude modulator 36 which modulates the amplitude of the spectrally designed signal using a low duty cycle data pulse 37, therefore embedding the data in the optical signal, as is well known in the art. An encoder 38 is then coupled to the amplitude modulator 36 for receiving the modulated spectrally designed signal therefrom, separating it into its intrinsic wavebands and time spreading these wavebands according to a predetermined code, thereby obtaining the spectro-temporally encoded light signal. Preferably, the encoder 38 is embodied by a series of fiber Bragg gratings 40 each reflecting one of the wavebands, positioned and distanced from each other in order to generate the delay between the wavebands required by the selected code. In the preferred embodiment, the Bragg gratings 40 are provided in a length of optical fiber 42 coupled to the fiber output of the modulator 36 by a three port optical circulator 44 forwarding the encoded signal to the output of the device 46. It is preferable that the 3-port circulator 44 be blocking for the path from the output 46 to the modulator 36, as indicated by the “X” on the schematic diagram, to prevent outside light from entering the source 34. It must be noted that in this embodiment, polarisation alignment may be required at the modulator input if the modulator is polarisation dependent as in the case of electro-optic Mach-Zehnder modulators. Since the EDF-SFS is unpolarized, a polarizer should be added in such a case.

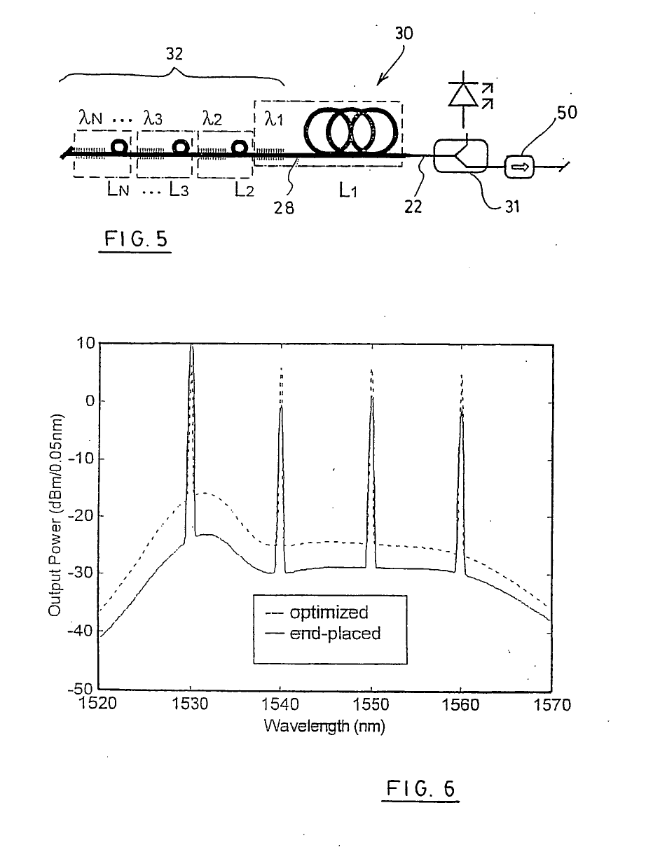

Referring to FIG. 5, there is shown another embodiment of the waveband source 34 where each FBG of the wavelength dependent reflector 32 is inscribed directly in the EDF embodying the gain medium 28. In this example, the gain medium 28 is backward pumped. The reflector 32 is preferably placed at an optimised position along the EDF to yield increased output power compared to end-placed multiwavelength Bragg grating (MWBG). In this embodiment, an optical isolator 50 is preferably disposed at the output of the waveband source 34 for preventing outside light from entering the source 34. FIG. 6 shows a typical output power spectrum showing the comparison between optimised and end-placed MWBG. The optimised spectrum is flatter than the end-placed one in the case of high reflectivity (near 100%) MWBG, similar flatness can be obtained in the end-placed configuration if a low reflectivity (about 3%) FBG at 1530 nm is used. However, the output spectrum is very sensitive to reflectivity changes at 1530 nm and accurate low reflectivity FBGs are difficult to make. The added degrees of freedom provided by placing the FBGs along the EDF allows for a more robust design and easier spectrum tailoring. This optimised FBG placement technique can also be applied to the gain flattening of erbium-doped fiber amplifiers (EDFA), see for example J.-C. Dung et al., Electronics Letters, vol. 34, no. 6, pp. 555-556, 1998.

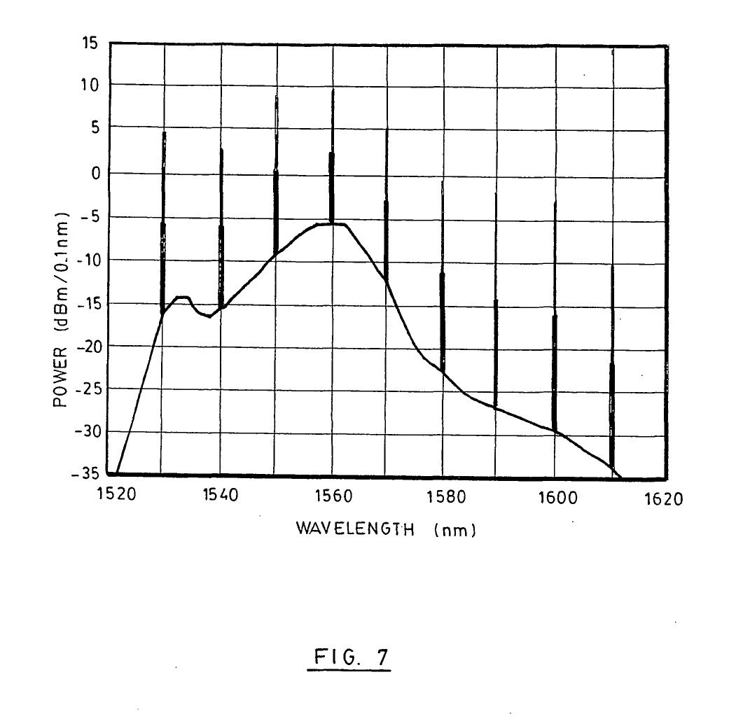

Referring now to FIG. 7, there is shown a broadband spectrum (between 1530 and 1610 nm) obtained by placing a group of FBGs at the backward end of the fiber (as shown in FIG. 3) to reflect the L-band (1580-1610 nm), and another group within the EDF (as shown in FIG. 5) to reflect the C-band (1530-1570 nm). This shows the possibility to cover both the C and L bands with this source configuration. These results can be obtained only with 1480 nm backward pumping if the simple (single-stage, single pump) configuration of FIG. 5 is used. Also output power uniformity could be improved by the use of loss filters, such as long period fiber Bragg gratings (LPG), within the EDF.

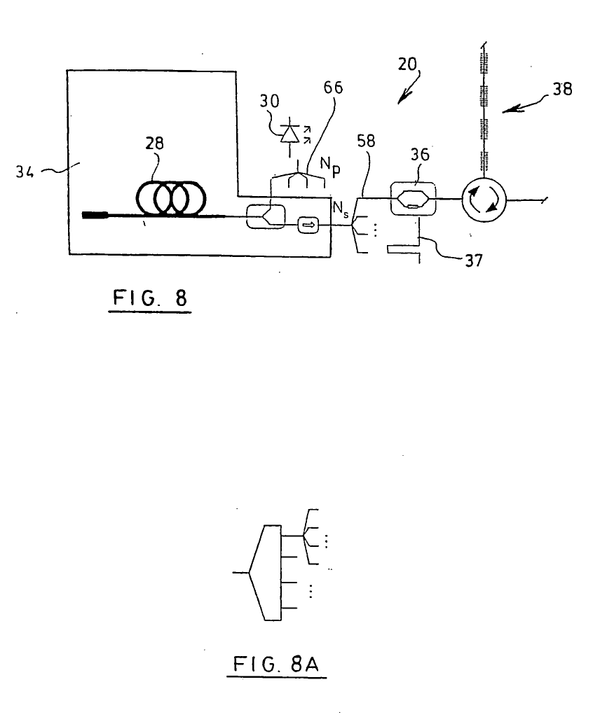

FIG. 8 is a diagram showing a typical system implementation of the transmitter 20 according to a preferred embodiment of the invention. In this embodiment, the output of the incoherent source 34 is split at the output by a power splitter 58, to be shared by Nₛ users (typically between 4 and 16). The transmitter 20 may therefore include as many modulators 36 and encoders 38 as there are users. This strategy is referred to as source sharing. It is also possible to realise source sharing by a combination of coarse WDM and splitters (shown in FIG. 8A) if the source spectrum is sufficiently broad. In addition, the pump power from the pump source 30 can be split by a pump splitter 60 to activate a number Nₚ of EDF (typically 2 to 4). This technique is called pump sharing. Overall source and pump sharing strategies provide a way to distribute the cost of the high power laser diode pump amongst many users. Depending on the encoder used, the transmitter of FIG. 8 can be used in “slice and delay” schemes, also called Frequency Hopping (FH), or “spectrum slicing” schemes, also called Frequency Encoding (FE), see for example T. Pfeiffer et al., Electronics Letters, vol.33, no.25, pp.2141-2142, 1997, or Incoherent Wavelength Division Multiplexing (I-WDM), see for example M. Zirngibl et al., IEEE Photonics Technology Letters, vol.8, no.5, pp.721-723, 1996, for multi-wavelength or single-wavelength output spectra respectively.

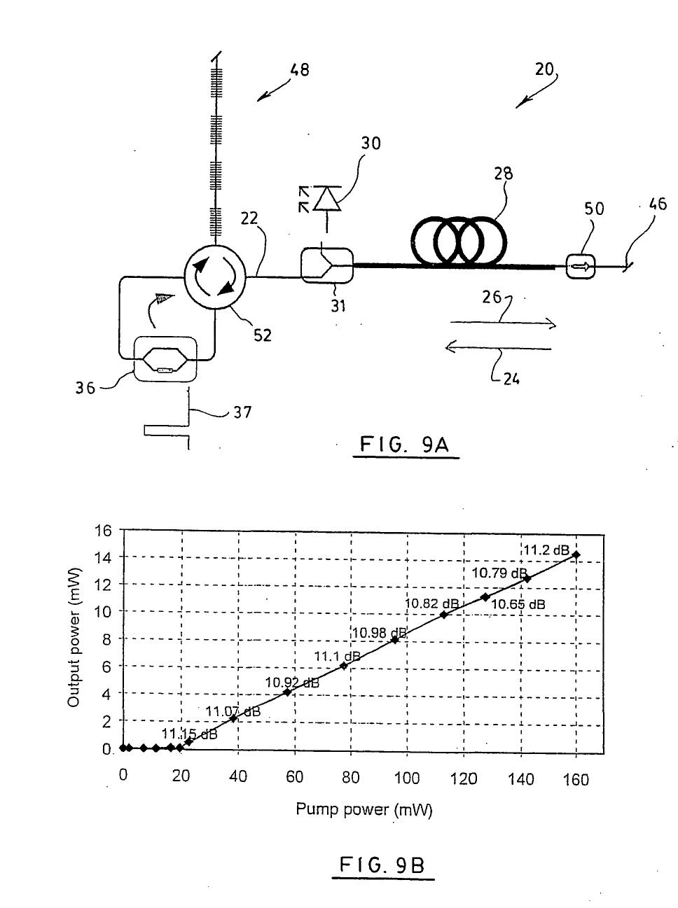

Referring to FIG. 9A, there is shown an optical transmitter 20 according to another preferred embodiment of the invention. In this particularly advantageous configuration, the amplitude modulator 36 is provided inside the source, backwards of the gain medium 28, therefore avoiding the significant insertion loss of an external amplitude modulator. In this configuration, the wavelength dependent reflector and the external encoder are replaced by a reflector 48 coupled to the modulator 36. In this manner, the backward propagating broadband signal generated by the gain medium 28 is modulated by the modulator 36 in accordance with the data to be embedded therein, and the modulated signal is then reflected by the reflector 48 into peak wavebands. For FH schemes, the waveband may be directly time spread in accordance with the predetermined code, so that the reflector 48 therefore performs the “slice and delay” operation from inside the incoherent source, to generate a spectro-temporally encoded light signal. This embodiment could however be used without time encoding for FE and I-WDM schemes. A directional optical sub-assembly is preferably provided for sequentially directing light from the backward end of the optical fiber 22 to the amplitude modulator 36, from the amplitude modulator 36 to the reflector 48, and from the encoding reflective element back into the optical fiber 22. In the illustrated embodiment of FIG. 9A, a 4-port circulator 52 is used for this purpose. The spectrally designed light signal then propagates in the fiber 22 in the forward direction 26, and advantageously amplified by the gain medium from its second passage therethrough. It is a very advantageous aspect of this embodiment that the amplification in the second pass is done on the already modulated signal, yielding higher gain than in the case of continuous-wave amplification. The signal exits the transmitter 20 at its forward output 46, which is preferably provided with an optical isolator preventing signals from the outside to enter the transmitter 20. FIG. 9B shows typical output power vs pump power curves for the set-up of FIG. 9A. Modulated output power of more than 14 mW with an extinction ratio of around 11 dB at 622 Mb/s has been obtained for 160 mW of pump power. This transmitter can be applied in FH, FE and I-WDM schemes.

Referring to FIG. 10, there is shown another embodiment of the present invention where, by changing the rotation direction of the directional optical sub-assembly, here embodied by the circulator 52, a pulsed waveband incoherent source 54 is realised. In this case, the modulator provided inside the source is a pulsing amplitude modulator 56 which modulates the broadband signal with short periodic pulses 57. This source 54 may be combined with an amplitude modulator 36 and encoder 38 to form a transmitter 20. In the illustrated embodiment, the pulsed source 54 can be shared by many users each having a lower bandwidth modulator 36 to add data on the pulsed signal. In this fashion there is only one high bandwidth pulsing modulator 56 needed for a group of users instead of one for each user. This concept is called modulator sharing.

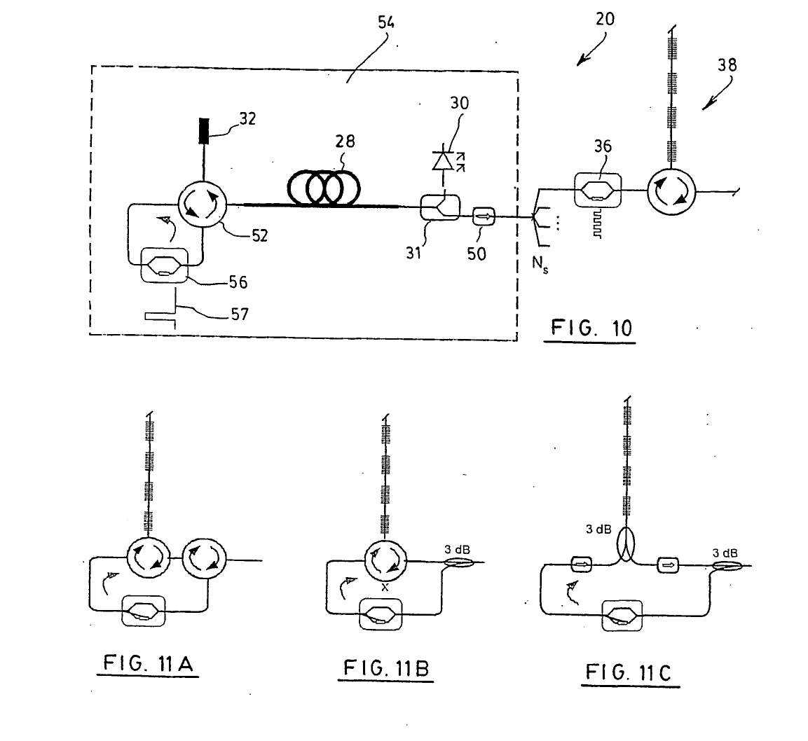

Referring to FIGS. 11A, 11B and 11C, alternate embodiments for the directional optical assemblies used in the embodiments of FIGS. 9A and 10 are shown. In FIG. 11A the 4-port circulator, presently not widely available on the components market, is simply replaced by two more common 3-port circulators. FIG. 11B replaces one of the 3-port circulators by a more affordable 3 dB coupler at the expense of increased insertion loss in the sub-assembly. In this case it is required that the 3-port circulator be blocking for one port pair as indicated by the “X” on the schematic diagram. FIG. 11C goes one step further than case II by replacing the last circulator by a 3 dB coupler. In this case, isolators need to be placed in the sub-assembly to emulate the circulating effect and reject unwanted reflections from the encoder.

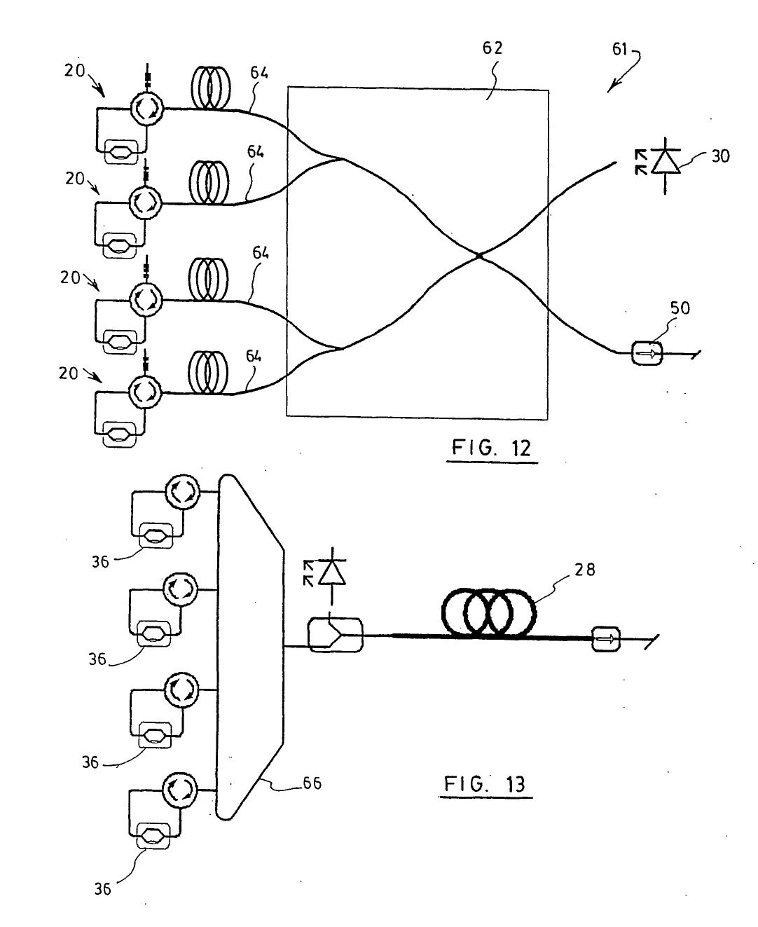

FIG. 12 is a diagram showing a transmitter array 61 embodiment of the invention that allows the simultaneous multiplexing of a multitude of transmitter signals along with splitting of the pump power needed in the pump sharing approach. The pump splitter/signal multiplexer sub-assembly 62 is a 2×N power splitter/combiner used bi-directionally, defining a cascade of wavelength independent couplers. From right to left, the pump power from a laser diode pump 30 is evenly delivered to the N EDF segments 64. Typically the pump wavelength is chosen to be around 1480 nm, close to the signal band around 1550 nm to ease the manufacturing constraints on the power splitter, but 980 nm pumping is also a possibility. From left to right, the various encoded/modulated signals from the transmitters 20, similar to the embodiment of FIG. 9A, are multiplexed by the power splitter/combiner 62. This transmitter array 61 can be applied in FH, FE and I-WDM schemes. In summary, the transmitter array 61 is made possible by the use of a bi-directional multi-purpose pump splitter/signal multiplexer sub-assembly.

FIG. 13 is a diagram showing an embodiment of the invention that is relevant to the generation of a multitude of incoherent wavelength division multiplexing signals (I-WDM). The array of I-WDM transmitters shares a single gain medium 28. The pumped EDF provides the ASE to the modulated fiber loops via a wavelength division multiplexer (WDM) 66. The WDM 66 demultiplexes the broadband signal (ASE) into spectrum slices that are routed to the loops and subsequently modulated by modulators 36. The modulated spectrum slices are then multiplexed by the WDM and fed to the EDF for further amplification. Here again, the transmitter array is made possible by the use of a bi-directional multi-purpose multiplexer sub-assembly.

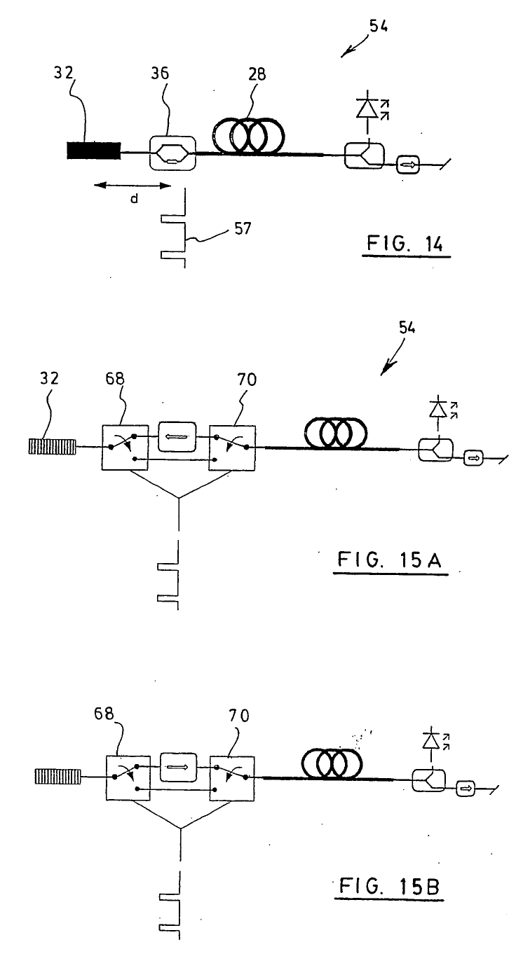

FIG. 14 is a diagram showing another embodiment of the spectrum-sliced pulsed fiber source 54, as an alternative to the embodiment of FIG. 10. Here the electrical clock signal 57 driving the modulator 36 has a period (T) that is related to the optical delay (2nd/c) of the ASE light that exits the gain medium 28 and that is reflected by the wavelength dependent reflector 32 back into the EDF gain medium 28 by the relation (N+α/2)T=2nd/c, where α=[0,1] is a relative delay that allows to adjust the duty cycle of the optical pulses coming out of the clock generator. Also, if the wavelength dependent reflector 32 is a MWBG then the optical reflection of each FBG must happen at integer multiples of the distance (d) to the first FBG. Sampled Bragg grating (SBG) or super-imposed Bragg gratings (SI-BG) can also be used as the wavelength dependent reflector with the same positioning limitation as a standard FBG, this being obvious to anyone well versed in the art. Furthermore, if a highly reflective and wavelength-selective coating is applied on the modulator back-facet, it is possible to drive the modulator 36 with data signals (non-periodic) 37 instead of a clock signal (periodic) 57. In that case, the bit rate is only limited by the round-trip time of the light in the modulator 36.

FIG. 15A is a diagram showing yet another embodiment of a spectrum-sliced pulsed fiber source 54. Here the repetition rate (1/T) is not limited by the optical delay of the light reflecting on the wavelength dependent reflector 32. The only limitation is the speed of synchronised first and second switches 68 and 70. For integrated electro-optic variable directional couplers acting as switches (see Saleh and Teich, Fundamentals of Photonics, chapter 18) modulation rates of >10 GHz are possible. The second switch 70 can be replaced by a 3 dB coupler for simplicity baring lower output power. This transmitter can be applied in FE and I-WDM schemes.

FIG. 15B is a diagram showing an embodiment of a transmitter. Here the optical isolator is reversed (with respect to FIG. 15A) to allow the optical pulses to be spectro-temporally encoded (FH scheme) something that cannot be done by the set-up of FIG. 15A where only spectral encoding is possible.

It must be noted that in FIGS. 3, 8, 9A, 9B, 10, 13, 14, 15A and 15B the pumped EDF can be replaced by a semiconductor optical amplifier (SOA).

It is understood that numerous modifications could be made to the embodiments described above without departing from the scope of the invention as defined in the appended claims.

1. An optical transmitter for transmitting data in a spectro-temporally encoded light signal, the transmitter comprising:
an optical fiber having a backward and a forward propagation direction, a gain medium being provided therein;
a pump source coupled to the optical fiber for injecting pump radiation in the gain medium, thereby enabling the generation by the gain medium of a broadband light signal, at least a portion of said broadband light signal propagating in the backward direction;
a wavelength dependent reflector coupled to the optical fiber for reflecting a portion of the backward propagating broadband light signal into a spectrally designed signal propagating in the forward direction, said spectrally designed signal having a plurality of peak wavebands;
an amplitude modulator coupled to the optical fiber forward of the gain medium for modulating an amplitude of the spectrally designed signal in accordance with said data; and
an encoder coupled to the amplitude modulator for receiving the modulated spectrally designed signal therefrom, said encoder separating the modulated spectrally designed signal into said wavebands and time spreading said wavebands according to a predetermined code to obtain the spectro-temporally encoded light signal.

2. The optical transmitter according to claim 1, wherein the gain medium is a rare-earth doped region of said optical fiber.

3. The optical transmitter according to claim 1, wherein said rare earth is erbium.

4. The optical transmitter according to claim 1, wherein said pump source is a laser diode coupled to the optical fiber by a wavelength dependent coupler.

5. The optical transmitter according to claim 4, wherein the pump radiation has a wavelength in the 980 nm pump band.

6. The optical transmitter according to claim 4, wherein the pump radiation has a wavelength in the 1480 nm pump band.

7. The optical transmitter according to claim 1, wherein the pump source is coupled to the optical fiber backwards of the gain medium.

8. The optical transmitter according to claim 1, wherein the pump source is coupled to the optical fiber forward of the gain medium.

9. The optical transmitter according to claim 1, wherein the wavelength dependent reflector is provided in a region of the fiber backwards of the gain medium.

10. The optical transmitter according to claim 1, wherein the wavelength dependent reflector is provided in a backwards portion of said gain medium.

11. The optical transmitter according to claim 1, wherein the wavelength dependent reflector comprises a plurality of Bragg gratings.

12. The optical transmitter according to claim 11, wherein said Bragg gratings are photoinduced into the optical fiber.

13. The optical transmitter according to claim 1, further comprising an optical isolator provided in the optical fiber forward of the gain medium, said optical isolator blocking backward propagating light incident thereon.

14. The optical transmitter according to claim 1, further comprising an optical circulator sequentially directing light from the optical fiber forward of the modulator to the encoder and from the encoder back into the optical fiber to propagate therein in the forward direction.

15. The optical transmitter according to claim 14, wherein the optical transmitter is blocking to light propagating in the backward direction.

16. A pulsed waveband incoherent light source for generating a pulsed spectrally designed signal, said light source comprising:
an optical fiber having a backward and a forward propagation direction, a gain medium being provided therein;
a pump source coupled to the optical fiber for injecting pump radiation in the gain medium, thereby enabling the generation by the gain medium of a broadband light signal, at least a portion of said broadband light signal propagating in the backward direction;
a wavelength dependent reflector coupled to the optical fiber for reflecting a portion of the backward propagating broadband light signal into a spectrally designed signal propagating in the forward direction, said spectrally designed signal having a plurality of peak wavebands; and
a pulsing amplitude modulator coupled to the optical fiber backwards of the gain medium for pulsing the spectrally designed signal.

17. The pulsed waveband incoherent source according to claim 16, further comprising a directional optical sub-assembly sequentially directing light from a backward end of the optical fiber to the wavelength dependent reflector, from the wavelength dependent reflector to the pulsing amplitude modulator, and from the pulsing amplitude modulator back into the optical fiber.

18. The pulsed waveband incoherent source according to claim 17, wherein said directional optical sub-assembly comprises a four port optical circulator.

19. The pulsed waveband incoherent source according to claim 16, wherein said peak wavebands of the pulsed spectrally designed signal are adapted for spectro-temporal encoding thereof.

20. The pulsed waveband incoherent source according to claim 19, in combination with:
an amplitude modulator coupled to the optical fiber forward of the gain medium for modulating an amplitude of the pulsed spectrally designed signal in accordance with transmission data; and
an encoder coupled to the amplitude modulator for receiving the modulated spectrally designed signal therefrom, said encoder separating the modulated spectrally designed signal into said wavebands and time spreading said wavebands according to a predetermined code to obtain a spectro-temporally encoded light signal.

21. An optical transmitter for transmitting data in a spectrally designed light signal, the transmitter comprising:
an optical fiber having a backward and a forward propagation direction, a gain medium being provided therein;
a pump source coupled to the optical fiber for injecting pump radiation in the gain medium, thereby enabling the generation by the gain medium of a broadband light signal, at least a portion of said broadband light signal propagating in the backward direction;
an amplitude modulator coupled to the optical fiber backward of the gain medium for modulating an amplitude of the broadband light signal in accordance with said data; and
a wavelength dependent reflector coupled to the amplitude modulator to receive therefrom the modulated broadband light signal, the wavelength dependent reflector reflecting said modulated broadband light signal into peak wavebands defining said spectrally designed light signal.

22. The optical transmitter according to claim 21, wherein the gain medium is a rare-earth doped region of said optical fiber.

23. The optical transmitter according to claim 21, wherein said rare earth is erbium.

24. The optical transmitter according to claim 21, wherein said pump source is a laser diode coupled to the optical fiber by a wavelength dependent coupler.

25. The optical transmitter according to claim 24, wherein the pump radiation has a wavelength in the 980 nm pump band.

26. The optical transmitter according to claim 24, wherein the pump radiation has a wavelength in the 1480 nm pump band.

27. The optical transmitter according to claim 21, wherein the pump source is coupled to the optical fiber backwards of the gain medium.

28. The optical transmitter according to claim 21, wherein the pump source is coupled to the optical fiber forwards of the gain medium.

29. The optical transmitter according to claim 21, wherein the wavelength dependent reflector comprises a plurality of Bragg gratings.

30. The optical transmitter according to claim 21, further comprising an optical isolator provided in the optical fiber forward of the gain medium, said optical isolator blocking backward propagating light incident thereon.

31. The optical transmitter according to claim 21, wherein the wavelength dependent reflector is coupled to the optical fiber to propagate the spectrally designed light signal therein in the forward direction.

32. The optical transmitter according to claim 31, further comprising a directional optical sub-assembly, sequentially directing light from a backward end of the optical fiber to the amplitude modulator, from the amplitude modulator to the encoding reflective element, and from the encoding reflective element back into the optical fiber.

33. The optical transmitter according to claim 32, wherein said directional optical sub-assembly comprises a four port optical circulator.

34. The optical transmitter according to claim 21, wherein the wavelength dependent reflector time spreads said peak wavebands according to a predetermined code to spectro-temporally encode said spectrally designed light signal.

35. An optical transmitter array for transmitting a plurality of data in a multiplexed plurality of spectrally designed light signals, said transmitter comprising:
a plurality of optical transmitter, each comprising:
a length of optical fiber having a backward and a forward propagation direction, a gain medium being provided therein, said gain medium generating a broadband light signal upon pumping thereof, at least a portion of said broadband light signal propagating in the backward direction;
an amplitude modulator coupled to the optical fiber backward of the gain medium for modulating an amplitude of the broadband light signal in accordance with corresponding data; and
an wavelength dependent reflector coupled to the amplitude modulator to receive therefrom the modulated broadband light signal, the wavelength dependent reflector reflecting said modulated broadband light signal into peak wavebands defining one of said spectrally designed light signals;
the transmitter array further comprising:
a pump source for injecting pump radiation into the gain medium of each optical transmitter;
an output for outputting the multiplexed plurality of spectrally designed light signals; and
a bi-directional coupling sub-assembly for respectively:
along the backward direction, splitting the pump radiation into a plurality of pump radiation portions, and injecting each of said pump radiation portions into the length of optical fiber of one of the optical transmitter to pump the corresponding gain medium; and
along the forward direction, multiplexing the spectrally designed light signals from each of the optical transmitters to obtain the multiplexed plurality of spectrally designed light signals, and directing the same towards the output.

36. The optical transmitter array according to claim 35, wherein said bi-directional coupling sub-assembly comprises a cascade of wavelength independent couplers.

37. An optical transmitter array for transmitting a plurality of data in a multiplexed plurality of waveband light signals, said transmitter array comprising:
an optical fiber having a backward and a forward propagation direction, a gain medium being provided therein;
a pump source coupled to the optical fiber for injecting pump radiation in the gain medium, thereby enabling the generation by the gain medium of a broadband light signal, at least a portion of said broadband light signal propagating in the backward direction;
a plurality of amplitude modulators coupled to the optical fiber backward of the gain medium for receiving therefrom a waveband light signal and modulating an amplitude thereof in accordance with corresponding data; and
a wavelength division multiplexer connected to the optical fiber backward of the optical fiber for receiving therefrom the broadband light signal, said wavelength division multiplexer having a plurality of ports each coupled to one of the amplitude modulators, the wavelength division multiplexer transmitting one waveband light signal of the broadband light signal to each of said port and receiving therefrom said waveband light signal after modulation, the wavelength division multiplexer further multiplexing the waveband light signals into the multiplexed waveband light signal and coupling the same back into the optical fiber.
